(19) United States
(12) Patent Application Publication
(10) Pub. No.: US 2006/0168057 A1
(43) Pub. Date: Jul. 27, 2006

(54) Method and system for enhanced electronic mail processing

(75) Inventors: Douglas Warren, Menlo Park, CA (US); Carl Gutekunst, Los Altos, CA (US); Des Cahill, Los Altos, CA (US); Scott Boyd, San Carlos, CA (US); Larry Ellis, San Jose, CA (US); Charles Swenberg, Mill Valley, CA (US); Josh Stivers, San Jose, CA (US)

Correspondence Address: Brian M. Berliner;O'MELVENY & MYERS LLP, 400 South Hope Street, Los Angeles, CA, 90071-2899, US

(73) Assignee: HABEAS, INC.

(21) Appl. No.: 11/245,984

(22) Filed: Oct. 6, 2005

Related U.S. Application Data
(60) Provisional application No. 60/616,792, filed on Oct. 6, 2004.

(51) Int. Cl. G06F 15/16

(52) U.S. Cl. 709/206

(57) ABSTRACT

An asynchronous proxy server system interposed between sender and recipient mail transfer agents, or other agent on the sender side, is configured to classify outgoing mail. Message and message header information is processed and compared against a set of business rules. The message header is modified to reflect an assertion based on an outcome of the comparison. The modified outgoing message is then routed to its destination.

### CROSS-REFERENCE TO RELATED APPLICATION

This application claims priority pursuant to 35 U.S.C. §119(e) to U.S. Provisional Application No. 60/616,792, filed Oct. 6, 2004, which application is specifically incorporated herein in its entirety, including its Exhibits A, B and C, by reference.

### BACKGROUND OF THE INVENTION

1. Field of the Invention

The present invention relates generally to the field of electronic mail sending processing. More specifically, the present invention relates to methods and systems for enhanced electronic mail verification, authentication, and assured delivery.

2. Description of Related Art

Various methods and systems are known in the art for detecting spam, filtering electronic mail, classifying messages, verifying sender identities, and other such actions intended to prevent electronic mail recipients from receiving unsolicited mail. Such technologies are necessary and useful, because unsolicited e-mail continues to be an effective, low cost way to solicit legitimate business and in some cases, to defraud consumers. Thus, senders of mass e-mail continue to devise ways to circumvent existing spam protection measures, message handling becomes more and more complex, and many e-mail recipients continue to receive an unacceptably large amount of unsolicited mail.

At the same time, it is desirable for the email system to retain the ability to send and receive an acceptable quantity and quality of commercial e-mail. Many consumers would like to receive a reasonable quantity of solicitations from trusted vendors, as this can be a convenient way for consumers to select and purchase goods and services that they are interested. Also, maintaining viable commercial uses for electronic mail is important for creating incentives for investment in e-mail infrastructure.

It is desirable, therefore, to provide a method and system that simplifies spam protection for consumers, permits desirable forms of commercial e-mail, and effectively protects recipients from spam and other forms of undesirable unsolicited e-mail.

### SUMMARY OF THE INVENTION

In general, the present invention provides systems and methods for improved electronic mail deliverability, that overcome the limitations of the prior art. In an embodiment of the present invention, an electronic mail verification method is provided comprising the steps of receiving a query from a recipient of an electronic mail message. The query comprises a message element added or modified by the message sender or an agent of the message sender. The query is applied to a message sender database which returns a coded response comprising information about the message sender. The coded response is returned to the message recipient for use in evaluating the desirability of the electronic mail message.

In another embodiment of the present invention, a method is provided for categorizing an outbound electronic mail message. The method generally comprises several of the following steps. A set of business rules is applied to the outgoing electronic mail message, thereby establishing an expected rating or content for the message. The message is then classified according to the expected rating or content. The message may be amended such that the message comprises a modified message element reflecting the expected rating or content of the message. The set of business rules may determine one or more routing parameters for the outbound electronic mail message. The modified message element may be one or more of a sender IP address, a reputation designator (for example a Habeas Warrant Mark™, Habeas, Inc., Palo Alto, Calif.), a reputation seal (for example a Habeas Seal™), a dynamically enhanced bounce address (for example a Habeas™ bounce address), a feedback link, an authenticated Internet domain name, and the like.

In an alternative embodiment of the present invention, a method is provided for assigning an outbound electronic mail message to a class. A campaign manager server (for example a Habeas™ Reputation Server) may be queried to obtain a sending parameter or parameters corresponding to the rating or content. Alternatively, the sending parameter or parameters may be generated by a sender side mail user agent or sender side mail transfer agent. An authenticating characteristic of the sending server, such a for example a source IP address of the outbound electronic mail message or the authenticated domain name of the sender is captured. In addition, one or more message elements of the outbound electronic mail message as well as information about the list and the sender's practices are evaluated with a set of business rules, thereby obtaining a rating of the outbound electronic message or messages.

Next, an outbound SMTP connection is accepted from a sender mail transfer agent. The outbound SMTP connection generally comprises the outbound electronic mail message. A message element is amended in the outbound electronic mail message and/or attached to the outbound electronic mail message. The amended or attached message element is based on the sending parameter or parameters. The amended or attached message element may comprise one or more of: a sender IP address, a reputation or certification designator, a reputation or certification seal, a dynamically enhanced bounce address, and an authenticated Internet domain name. The reputation designator may comprise an electronic signature that uniquely identifies a message originator; and the reputation seal may comprise an active hyperlink and/or comparable means whereby a consumer who receives and views the outbound electronic mail message may provide feedback. The outbound electronic mail message is then delivered to a receiver-side mail transfer agent.

In another embodiment of the present invention, an asynchronous SMTP proxy server (ASPS) is provided. The ASPS generally comprises an SMTP server that accepts an outbound electronic message from a sender's mail transfer agent and sends the outbound electronic message to a receiver's mail transfer agent. Additionally, the ASPS comprises an SMTP client that assigns a designated sender IP address from which the outbound electronic message is sent to the receiver's mail transfer agent. The SMTP client maintains a connection to the sender's mail transfer agent and establishes a dynamic, separate connection to the receiver's mail transfer agent. A memory-based scheduler is included for managing a message queue. The scheduler notifies the SMTP client that sufficient information is available to proceed with sending the outbound electronic message.

In this embodiment, the ASPS may operate as an internet appliance or application server (also referred to as a warrant mark engine or a rules applicator) for identifying the outbound electronic message as a bulk message belonging to a campaign and for assigning the designated sender IP address appropriate for the campaign. The ASPS includes a filter application filter interface (API) that supports a disk-based queue and/or memory streaming- to support a large outbound electronic message as well as a logging module for recording a delivery event, a communications status, and/or an error event. This feature permits an ASPS according to the present invention to act as a general purpose mail filter. Applications of this general purpose mail filter could include a virus scanner, other classification tasks for outbound mail messages, digital signing, verifying a sender's credentials based on the content of the message, and examining outbound mail messages for sensitive content.

In another embodiment of the present invention, a method is provided for managing a connection between a sender's mail transfer agent and a receiver's mail transfer agent. The method generally comprises the steps of establishing the connection and comparing a message element of an outbound message with an expected data structure. This comparison is advantageously performed while the connection is maintained. The message element is amended if the message element differs from the expected data structure. The outbound message is delivered to the receiver's mail transfer agent, and the connection is terminated.

In general, a separate mechanism is required to authenticate Internet Domain names, such as for example the Domain Keys Identified Mail (DKIM) method, as under development by the Internet Engineering Task Force (IETF) (www.ieff.org). In a nutshell, DKIM comprises a method whereby a message recipient can query a signer's domain to determine, using a public key, whether or not the private key that was used to sign the message was authorized by the domain for the sender's address. This confirms that an authorized sender sent the message. The current invention can use this authentication advantageously, similar to the way it can use a source IP address or the dynamically enhanced bounce address.

A more complete understanding of the method and system for electronic mail will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1A is a schematic diagram showing elements of a prior art electronic mail sending, transmission, and delivery system.

FIG. 1B is a schematic diagram showing elements of an electronic mail sending, transmission, and delivery system according to one embodiment of the present invention.

FIG. 1C is a schematic diagram showing elements of an electronic mail sending, transmission, and delivery system according to another embodiment of the present invention.

FIG. 2 is a schematic diagram showing elements of a system for managing reputation scoring and classification of electronic mail according to an embodiment of the present invention.

FIG. 3 is a flowchart diagram showing exemplary steps for using campaign information to mark an outgoing message with a desired indication of message class.

FIG. 4A is a flowchart diagram showing exemplary steps performed by a sender-side MTA according to an embodiment of the present invention.

FIG. 4B is a flowchart diagram showing exemplary steps performed by an asynchronous proxy server and sender-side MTA according to an embodiment of the present invention.

FIG. 5A is a flowchart diagram showing exemplary steps performed by a sender-side MTA according to another embodiment of the present invention.

FIG. 5B is a flowchart diagram showing exemplary steps performed by an asynchronous proxy server and sender-side MTA according to another embodiment of the present invention.

FIG. 6A is a flowchart diagram showing exemplary steps performed by a receive-side MTA according to an embodiment of the present invention.

FIG. 6B is a flowchart diagram showing exemplary steps performed by an asynchronous proxy server and receive-side MTA according to an embodiment of the present invention.

FIG. 7A is a flowchart diagram showing exemplary steps performed by a mail delivery agent according to an embodiment of the present-invention.

FIG. 7B is a flowchart diagram showing exemplary steps performed by a mail delivery agent in cooperation with an asynchronous proxy server according to an embodiment of the present invention.

FIG. 8 is a flowchart diagram showing exemplary steps performed by a receiver-side MUA according to an embodiment of the present invention.

FIG. 9 is a flowchart diagram showing exemplary steps performed by a feedback system according to an embodiment of the present invention.

FIG. 10 is a flowchart diagram showing exemplary steps performed by a administration and management system according to an embodiment of the present invention.

### DETAILED DESCRIPTION OF THE PREFERRED EMBODIMENT

The invention provides systems and methods for electronic mail handling, that overcome the limitations of the prior art. It should be appreciated that the scope of the invention is not limited to the various exemplary embodiments described herein, and may extend to other embodiments within the scope of the appended claims. In the detailed description that follows, like element numerals are used to denote like elements appearing in one or more of the figures.

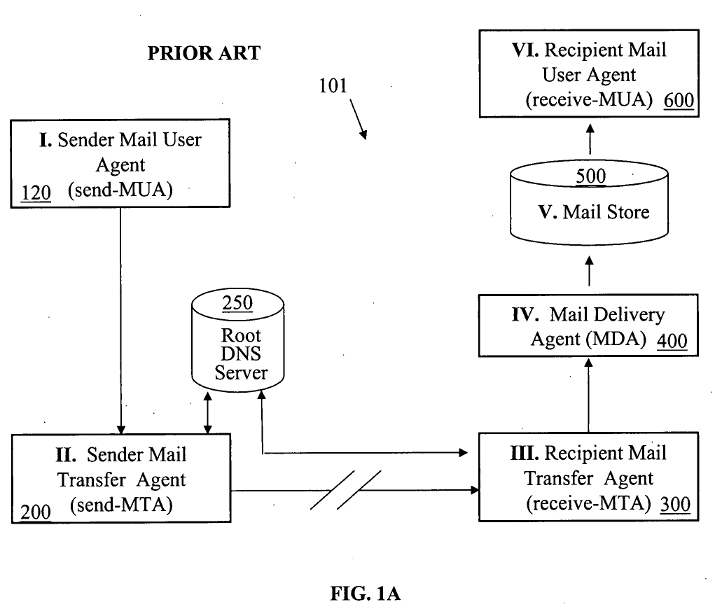

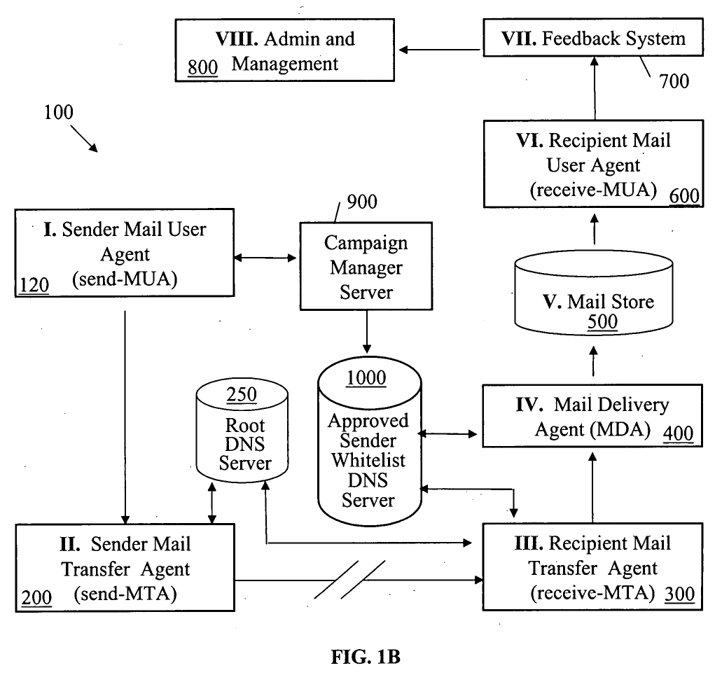

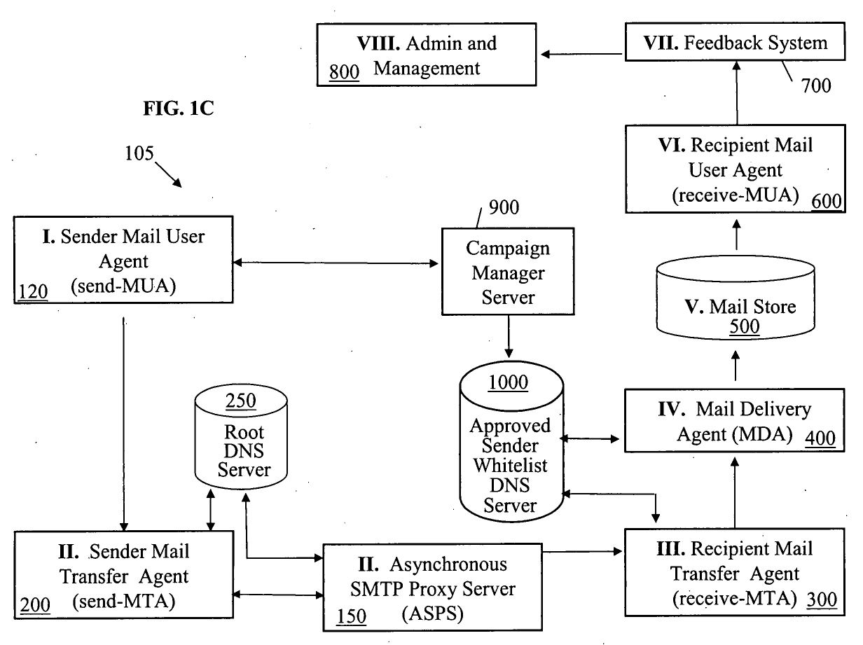

Referring to FIG. 1A, general protocols for generating, sending, receiving, and processing an electronic mail message may be configured as follows. The mail sending and receiving architecture 101 generally includes a sender-side mail user agent (send-MUA) 120, a sender-side mail transfer agent (send-MTA) 200, a public DNS server 250, a receiver-side mail transfer agent (receive-MTA) 300, a mail delivery agent (MDA) 400, a message store 500 (also referred to as a mail store), and a receiver-side mail user agent (receive-MUA) 600.

With reference to FIG. 1B, an electronic mail system 100 according to one embodiment of the present invention further comprises a feedback system 700, an administration and management module 800, a campaign manager server 900, and an approved/registered/assured sender whitelist DNS server 1000. The operation of these additional components is described below in reference to interactions with the architecture of existing electronic mail systems. Servers and agents may be implemented using suitable servers and modules as known in the art.

FIG. 1C shows an exemplary electronic mail system 105 that includes an asynchronous proxy server system (ASPS) 150 interposed between the send MTA 200 and the receive MTA 300. The ASPS 150 receives outbound messages from the send-MTA and modifies message attributes, for example a sender or source IP address, based on message characteristics, ratings, classification or certification. The ASPS routes the modified message to the receive-MTA 300. Operation of system 105 and further details concerning embodiments of the ASPS 150 are described in more detail later in the specification.

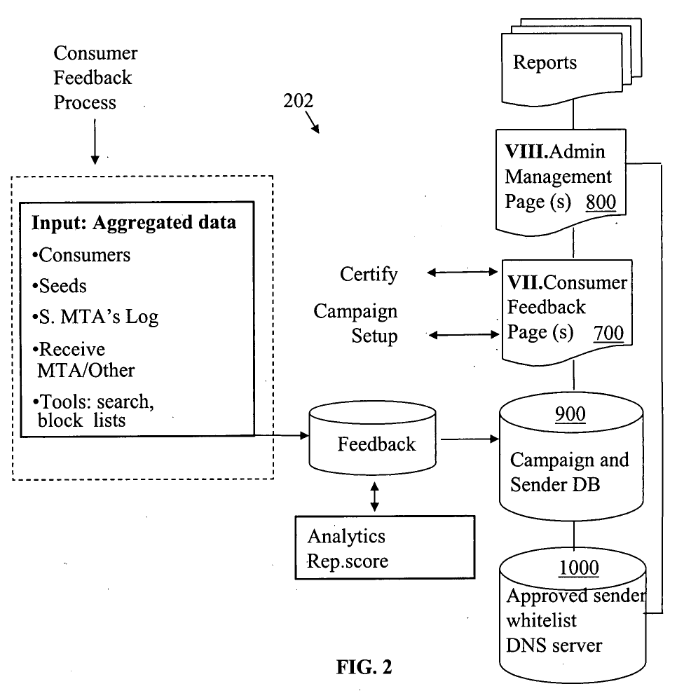

FIG. 2 shows an exemplary system 202 for obtaining customer feedback used for rating or classifying electronic mail. System 202 collects user feedback from feedback pages 700 presented on receive-MUA or other receiver-side client. Feedback may be collected and processed using a sender-side MTA or other server, and maintained in a campaign or sender database 900. An administrator client 800 may be used to review feedback data and update an approved sender database 1000 or similar screening criteria applicable to outgoing messages. Further details concerning system 202 and its method of operation are provided later in the specification.

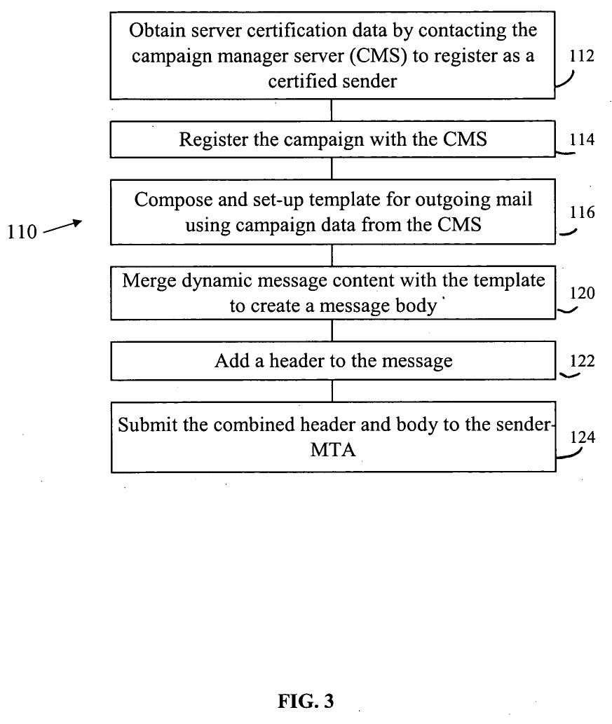

FIG. 3 shows exemplary steps of a method 110 for using campaign information to mark an outgoing message with a desired indication of message class. Initially, a send-MUA may obtain certification data by contacting the campaign manager server (CMS) to register as a certified sender, at step 112. Any suitable communication and certification process may be used, with appropriate security precautions taken as known in the art to prevent sender identity theft and verify the identity and qualifications of senders.

For each subsequent mail campaign, the sender registers the campaign with the CMS using a similar process, at step 114. This may include providing the CMS with information about the campaign, including time, duration, message size & subject, message content, number or identity of recipients, and other details. The CMS then issues a secure registration identifier to the sender.

At step 116, the send-MUA 120 may compose and set up a template for outgoing mail using campaign data from the CMS. The template may include common information to be sent to all recipients of the message and input fields to obtain customized, recipient-specific or other “dynamic” content. At step 120, a database of this dynamic content may be merged with the template to create the body of one or more messages. For each message, a header is added to the message at step 122. This header makes one or more assertions about the message body, such as for example the author of the message, the message subject, the date the message was composed, and so forth. The combined header and body are presented to the send-MTA 200 at step 124. Along with the body and header, a recipient address or addresses and a bounce address (also referred to as an envelope originator) in proper RFC 2821 form are also presented to the send-MTA 200.

In one embodiment of the present invention, the step 116 performed at the send-MUA 120 of composing and setting up the mail template is enhanced. According to this embodiment, one or more bulk mail campaigns are registered with a campaign manager server 900. This registration may be manual, for example a sender accesses the server through a form on the world wide web, or automatic, for example via a machine-to-machine link over the Internet. In a manual embodiment, a sender of bulk e-mail contacts the campaign manager server, possibly via a web interface. The sender submits a campaign identification for the mail to be sent and defines the class of mail. The definition provided may be one of a set of classifications of mail that are established by the sender, such as for example transactional mail, confirmed opt-in mail (COI), single opt-in mail (SOI), refer-a-friend mail (RAF), or the like. In the alternative, the set of classifications may be simple, such as for example priority first class and second class based on one or more factors.

One or more recipient identifiers, such as for example a list of recipient names may also be provided to the campaign manager server, and the campaign information may be described. In response to this input, the campaign manager server 900 provides campaign data back to the send-MUA 120. The campaign data provided to the send-MUA 120 comprises one or more of a header template, a URL feedback link, a dynamically enhanced bounce address, an authenticated domain name, or some other form of key that identifies the sender. The header template may include a campaign identifier, other sender information, and a class of mail designator. The URL may comprise text and a link and/or an inline image such as a GIF or JPEG image and a link. Additional illustrative details regarding exemplary embodiments of the present invention with regards to the send-MUA, message headers, templates, dynamically enhanced bounce addresses, and the like are provided below.

In one embodiment of the present invention, a Sender Side mail user application (MUA 120) composes or sets-up a template. In one example, the MUA 120 obtains sender certification data, optionally by contacting the campaign manager server 900 to register as a certified sender at step 112. Sender certification data may be obtained for each mail message or campaign or alternatively obtained in advance and reused for multiple campaigns or messages. The certification process may include one or more of registering the sending IP address or IP addresses, registering the sending domain name and/or a domain key, certifying or otherwise identifying the classes of mail that the sender is authorized to send, defining list practices and content policies for the mail classes to be sent, collecting information about the internet history of the sender (for example: examine pre-existing sender reputation, historical spam scores, presence of sender on do-not accept (black) lists. For example, the registration information may identify the mail as one of a class of transactional mail, confirmed opt-in (COI) mail, single opt-in (SOI) mail, refer-a-friend (RAF) mail, or other classification. For further example, the campaign manager server 900 may provide campaign data to the MUA comprising (a) Header fields (includes campaign ID and class of mail designator plus a feedback link template that includes a URL template), (b) Feedback link including a URL template for inclusion in the template message body (this feedback link may be text+a link template or a GIF+a link template), (c) a dynamically enhanced bounce address, and (d) a private key for digitally signing an Internet domain name, such as for example using DKIM.

Thus, the MUA 120 merges dynamic content with the template to create a message body. The dynamic content may include, for example, one or more of the recipient address, recipient name, recipient-specific data, digital signature of the message content, and the like. The MUA 120 also adds a header to the message at step 122. The MUA 120 then submits the combined header and body, including recipient address(es) and a RFC 2821 compliant envelope originator (bounce address), to the send-MTA (200) (submission agent) at step 124.

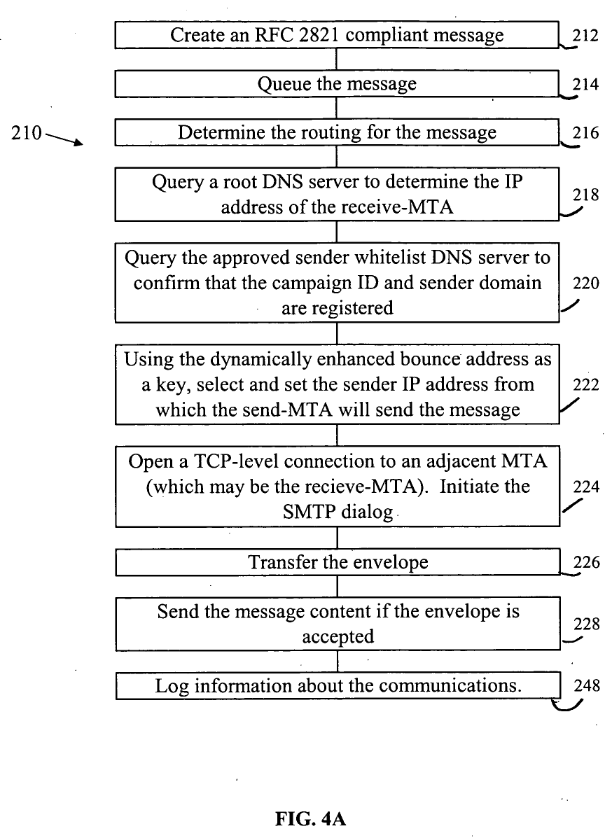

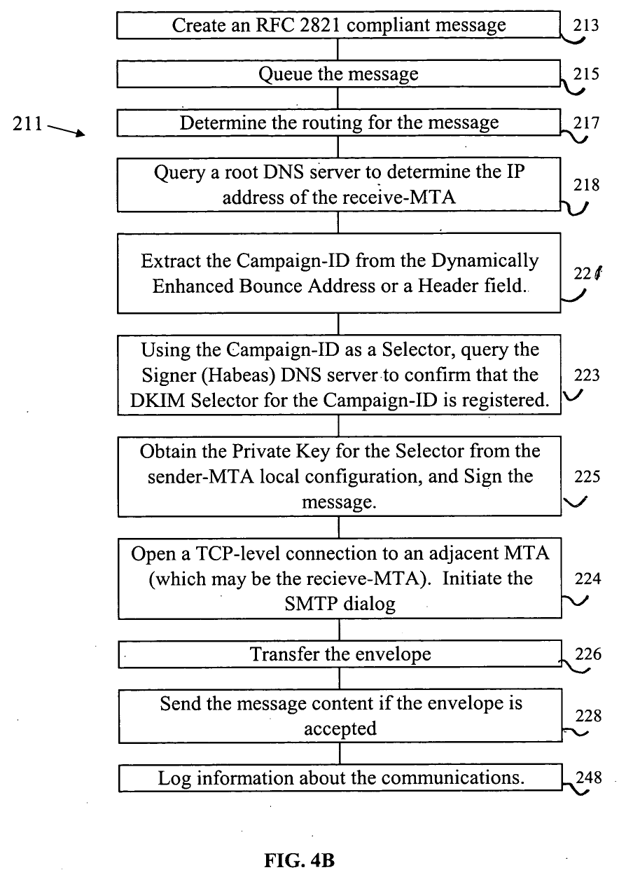

Exemplary steps of a method 210 that may be performed at the send-MTA 200 are summarized in FIG. 4A. At step 212, the send-MTA 200, or alternatively the send-MUA 120, creates an RFC 2821-compliant message by inserting the message elements into an envelope. The envelope includes the dynamically enhanced bounce address and the recipient address. The send-MTA 200 queues the message at step 214, and determines the necessary routing for the message at step 216. At step 218, the send-MTA 200 queries a root domain name system (DNS) server 250 or other directory service to determine the IP address of the destination MTA. It should be appreciated that the invention is not limited to the use of a DNS server, and any suitable directory server may be used, including but not limited to a domain name server, (b) a who is server, (c) a CCITT X.500 directory service, and (d) a public directory service using a Lightweight Directory Access Protocol. After obtaining the IP address, the send-MTA queries the approved sender whitelist DNS server to confirm that the campaign ID and sender domain are registered, at step 220. If the campaign and sender are not registered, the send-MTA may mark the message to indicate it is unregistered, or may dispose of the message in any desired manner, including but not limited to blocking or bouncing it back to the sender.

At step 222, the send-MTA 200 advantageously dynamically assigns the sender (source) IP address for the message, sometimes referred to as the “bounce address,” based on the class of mail, the content, the sender reputation, and/or other selected criteria. While advantageous, dynamic assignment of the sender IP address is not required to realize the benefits of the present invention. The sender may manually configure the sender IP address in accord with the proper class or content of the mail message or messages. In this manner, downstream spam filters may sort messages based on the sender IP address. If high reputation score mail is sent only from a restricted set of sender IP addresses, mail from these addresses may be preferentially received or designated as “not spam” to the end consumer of the mail.

At step 224, the send-MTA 200 opens a TCP-level connection to the receive-MTA 300, including for example an SMTP “EHLO”. In an embodiment of the invention, the send-MTA 200 communicates directly with the receive-MTA 300. In some cases, the destination MTA may be the receive-MTA 300. Alternatively, the destination MTA may be an adjacent MTA if the message routing involves multiple MTAs to deliver the message from the send-MTA 200 to the receive-MTA 300. One of ordinary skill in the art will understand that the processes described herein apply similarly if the message is routed via multiple intermediate MTAs. The envelope is transferred at step 226, and if the receive-MTA 300 accepts the envelope, the content is sent at step 228. Finally, information about the communication, including additional information such as, for example, the dynamically enhanced bounce address, is logged at step 248, along with information about the message to facilitate tracking and feedback of the message. The dynamically enhanced bounce address also offers the advantage of allowing the receive-MTA to assess the message prior to accepting the content.

FIG. 4B shows exemplary steps of a method 211 for using an authenticated Internet domain name, for example, a name authenticated using a Domain Keys Identified Mail (DKIM) selector in association with a campaign ID to verify source and campaign registration. Steps of method 211 may be the same as method 210, except for steps 221, 223, and 225. The send-MTA may extract a campaign ID from an enhanced bounce address or header field, as indicated at step 221. Registered bulk mail should comprise a campaign ID for bulk mail in addition to other header information. At step 223, the send-MTA may query an approved sender whitelist DNS server to confirm that a Domain Key Identified Mail (DKIM) selector or other public key for the campaign ID is registered. In addition, parameters of the bulk mail campaign for use in classifying the message may also be obtained.

At step 225, the send-MTA may obtain the private key for the DKIM selector from the send-MTA local configuration, and sign the message using the private key. In addition, send-MTA may add a class designator to the header of the outbound message, add a seal to the body of the message, or otherwise modify the message or message header to indicate a class of mail. If the message is bulk mail and is not registered, the outbound message may disposed of as previously described.

In summary of method 210, a sender-side Mail Transfer Agent (send-MTA 200) creates an RFC 2821 compliant message by inserting content into an envelope. This includes the bounce address and recipient address. Other tasks performed by the send MTA 200 include queuing the message, routing the message by routing the message by examining the recipient address and making routing decisions, and querying a public DNS 250 to determine the IP address of the receiver-MTA (this may be an intermediate/adjacent MTA). By querying the public DNS 250, the send MTA 200 confirms that the campaign ID or the sender domain are registered with the approved sender whitelist DNS server 1000. This may be accomplished using the dynamically enhanced bounce address as a key. In this example, the send-MTA 200 selects and sets the sender IP address from which the send-MTA 200 will send the message. In another example, the send-MTA 200 may attach and/or modify a message element such as for example a Domain Key Identified Mail (DKIM) element. This DKIM element may be a public or a private key according to current internet messaging standards.

The send-MTA 200 may also be configured to associate classes of mail or other mail stream characteristics with discrete source IP addresses. The send-MTA 200 may have multiple IP addresses associated with its mail services. In one embodiment, the IP addresses specify a machine as the source of the message but also make assertions about the characteristics of the message. The message/sender/campaign reputation is assigned and keyed to the bounce address in one embodiment. In other embodiments, a message element such as a public or private DKIM key are used to identify the sender, the message, or the campaign and to provide information about the asserted mail class and the reputation of the sender.

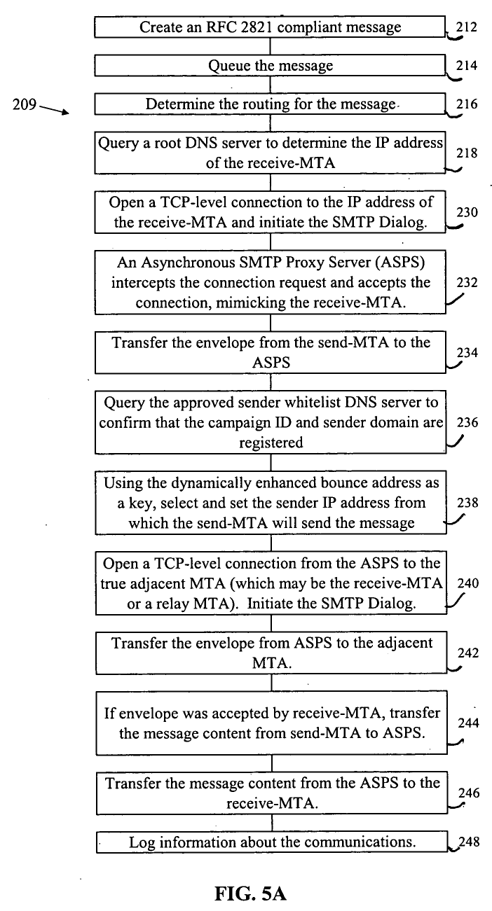

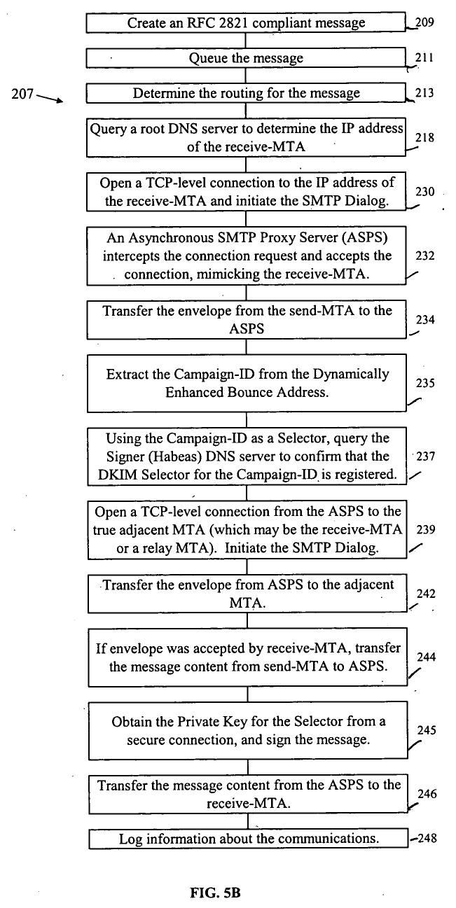

In the alternative, if the send-MTA 200 is not capable of either dynamically or manually setting the source IP address of the outbound mail, an asynchronous SMTP proxy server may be configured to receive outbound mail from the sent-MTA, process the outbound message, and provide processed outbound mail to the receive-MTA. FIG. 5A shows exemplary steps of a method 209 for using an ASPS for processing outbound electronic mail, in a system 105 as shown in FIG. 1C. An ASPS 150 according to the present invention may sit between the send-MTA and the Internet, processing outbound SMTP traffic. The ASPS 150 may accept outbound SMTP connections from a send-MTA 200, mimic the behavior of the receive-MTA 300 and capture the destination IP address. Steps 212, 214, 216 218 and 248 of method 209 may be the same as the like-numbered steps of method 210. Steps 213, 215, 217 and 218 may be performed by the send-MTA as in method 210. In method 209, the remaining steps should be performed by the ASPS 150.

Functions of an ASPS according to this embodiment include, but are not limited to, opening a TCP-level connection to the IP address of the receive-MTA and mimicking a send-MTA by initiating and maintaining an SMTP dialog, as indicated at step 230. Likewise, the ASPS also intercepts the send-MTA connection request and accepts the connection, mimicking the receive-MTA at step 232. At step 234, the message envelope is transferred to the ASPS. At step 236, the ASPS extracts the bounce address (SMTP MAIL FROM) or a campaign ID of a message, and queries the approved sender whitelist DNS server (for example the Habeas™ whitelist DNS server) 1000 to confirm that a Domain Key Identified Mail (DKIM) selector or other public key for the campaign ID is registered. In addition, the ASPS may obtain the parameters of the bulk mail campaign for use in classifying the message.

At step 238, the ASPS, using the dynamically enhanced bounce address as a key, may select and set the desired sender IP address. The sender IP address may be selected according to the message class. In addition, the ASPS may add a class designator to the header of the outbound message, add a seal to the body of the message, or otherwise modify the message or message header to indicate a class of mail. If the message is bulk mail and is not registered, the outbound message may disposed of as previously described. The message downstream of the ASPS will therefore be modified, but will appear to have come directly from the send-MTA indicated by the selected source IP address.

Further steps 242, 244, 246 and 248 may be the same as corresponding steps 224, 226, 228 and 248 in method 210, except that the ASPS should perform these steps so as to mimic the steps that the send-MTA would otherwise perform. At step 242, the ASPS may connect to the receive-MTA 300 at the sender IP address determined by the campaign ID and specified by the send-MTA 200 and/or the send-MUA 120. The modified message may be delivered to the receive-MTA 300 as indicated at steps 244 and 246. A log of the communications may be maintained as indicated at step 248. Additional details regarding exemplary embodiments of the present invention making use of an ASPS are provided below.

An ASPS according to one embodiment of the present invention may engage in multiple protocol exchanges with the sender SMTP (send-MTA), and then replay that exchange or a different set of exchanges with the receiver SMTP (receive-MTA). The Asynchronous Proxy may gather the TCP/IP connection parameters and message envelope from the send-MTA, apply rules or policies to the envelope, and alter the TCP/IP connection parameters and message envelope before passing these to the receive-MTA. These actions may be difficult to accomplish synchronously, because the send-MTA will not generally be configured to pass information in a synchronous order. For example, a synchronous proxy would be required to set the source IP address of the proxy before it has received the message envelope containing the information needed for setting the source IP address. Accordingly, an asynchronous proxy, although not known in the art for this application and subject to other difficulties, may be used to overcome this limitation of synchronous proxies.

The sender SMTP hostname, connection parameters, and originator address may be used to set the source IP address of the ASPS. This can be used to support white listing of different classes of service. As an additional advantage, policies may be enforced against the entire recipient list before sending any of the individual recipients to the receiver SMTP. Prior art synchronous proxy servers can only examine the recipients one at a time, as they are being exchanged between the receive-MTA and send-MTA. An asynchronous outbound server may therefore be used to ensure that desired processes of an electronic mail warranting service are maintained while avoiding triggering spam filters based on the number of recipients on the receiver SMTP. Additional details regarding exemplary embodiments of an ASPS according to the present invention are provided below.

In summary of the foregoing, an asynchronous proxy SMTP server (ASPS) may be used to mediate the handshake between the send-MTA 200 and receive-MTA 300 while dynamically setting the source IP address. In this embodiment, an RFC 2821 compliant message is created, the message is queued, the message routing is determined, a root DNS server is queried to determine the IP address of the receive-MTA, a TCP-level connection to the IP address of the receive-MTA is opened, and an SMTP dialog initiated. An ASPS intercepts the connection request and accepts the connection, thereby mimicking the receive-MTA. The envelope is transferred from the send-MTA to the ASPS. An approved sender whitelist DNS server 1000 is queried to confirm that the campaign ID and sender domain are registered. The sender IP address from which the send-MTA will send the message is selected and set using the dynamically enhanced bounce address as the key. A TCP-level connection from the ASPS to the true adjacent MTA, which may be the receive-MTA or a relay MTA, is opened. The SMTP dialog is initiated, and the envelope is transferred form the ASPS to the adjacent MTA. If the receive (adjacent) MTA accepts the envelope, the message content is transferred from the send-MTA to the ASPS. The message content is transferred from the ASP to the receive-MTA the ASPS logs information about communications. Logged information may include the dynamically enhanced bounce address for tracking and feedback. Alternatively, the logged information may include the public or private DKIM keys associated with the message.

FIG. 5B shows exemplary steps of a method 207 for using an authenticated Internet domain name, for example a Domain Keys Identified Mail (DKIM) selector in association with a campaign ID and ASPS to verify source and campaign registration. Steps of method 207 may be the same as identically-numbered steps of method 209, except for steps 235, 237, 239, and 245. The send-MTA may extract a campaign ID from an enhanced bounce address or header field, as indicated at step 235. At step 237, the send-MTA may query an approved sender whitelist DNS server to confirm that a Domain Key Identified Mail (DKIM) selector or other public key for the campaign ID is registered. In addition, parameters of the bulk mail campaign for use in classifying the message may also be obtained. At step 239, the ASPS opens a TCP-level connection from the ASPS to the true adjacent MTA, which may be the receive-MTA or a relay MTA, and initiates the SMTAP dialog.

The ASPS may transfer the message envelope to the adjacent MTA, and if the envelope is accepted, transfer the message content from the send-MTA to the ASPS, as indicated at steps 242 and 244. Advantageously, the message content need not be uploaded to the ASPS until the message envelope is accepted by the receive-MTA or relay MTA. At step 245, the send-MTA may obtain the private key for the DKIM selector or other authenticator from the send-MTA local configuration, and sign the message using the private key. In addition, send-MTA may add a class designator to the header of the outbound message, add a seal to the body of the message, or otherwise modify the message or message header to indicate a class of mail. The remaining steps of method 207 may be as previously described for method 209.

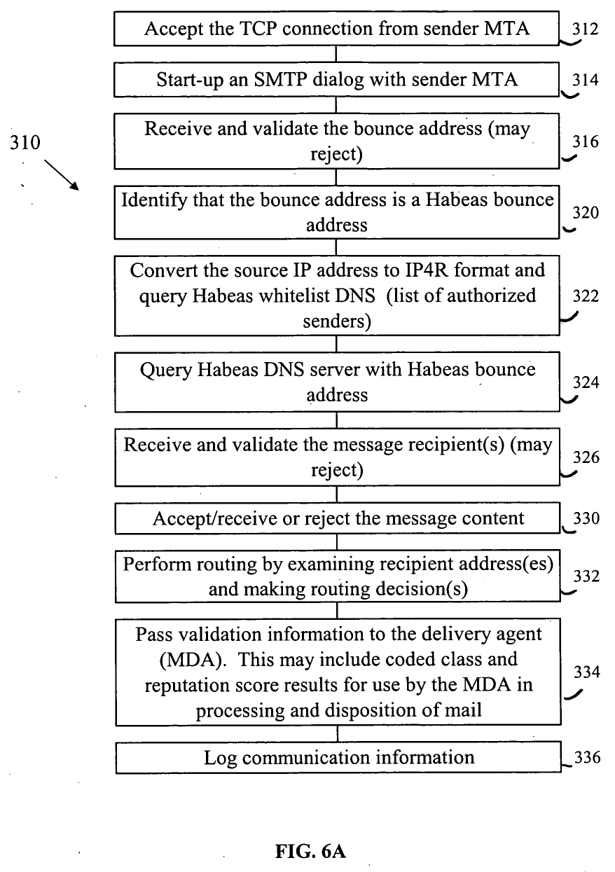

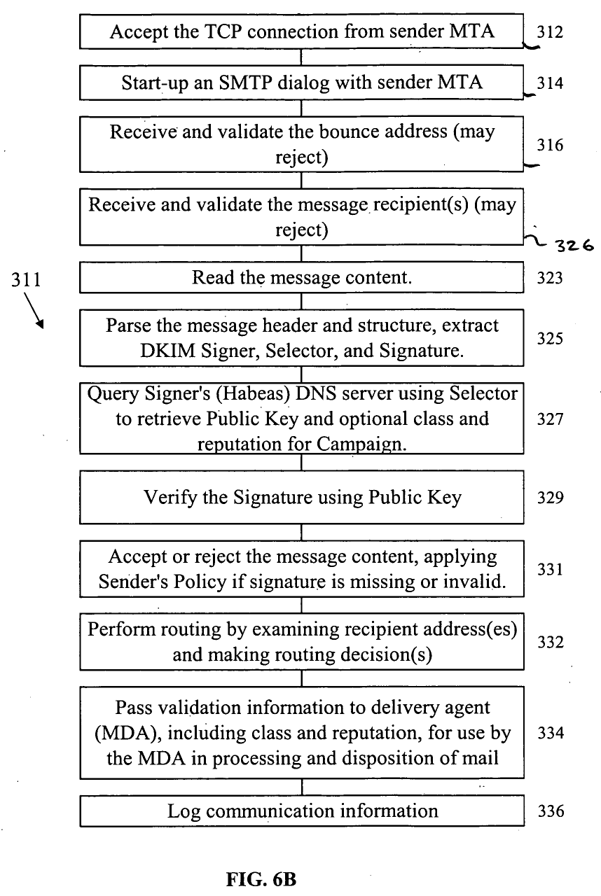

Exemplary steps of a method 310 that may be performed at the receive-MTA 300 according to an embodiment of the present invention are illustrated in FIG. 6A. The receive-MTA 300 accepts the TCP connection from the send-MTA 200 at step 312 and starts-up an SMTP dialog with the send-MTA 200 at step 314. The dynamically enhanced bounce address is accepted and validated at steps 316 and 320. The receive-MTA 300 may reject the message or identify the message for special treatment by the MDA 400 or one or more filters (for example those provided by SpamAssassin, Brightmail, etc.) Next, the list of recipients are received and validated at steps 322, 324 and 326. Again, the receive-MTA 300 may reject the recipient list. The content of the message is accepted/received or rejected at step 330. The recipient address is examined and routing determinations are made at step 332, and the message is passed to the MDA 400 at step 334. Communication information similar to that logged at the send-MTA 200 may be logged, as indicated at step 336.

If the receive-MTA 300 is not programmed according to the present invention, it remains operative to process incoming mail according to the prior art standards. However, if the receive-MTA 300 is compliant with the various improved aspects of the present invention, additional steps may be executed on incoming mail. Specifically, in the step of accepting and validating the bounce address, additional processing occurs because the bounce address is a dynamically enhanced bounce address. The receive-MTA 300 tentatively identifies the bounce address as a dynamically enhanced bounce address. This identification is tentative at this point because the dynamically enhanced bounce address may be forged and/or spoofed. The source IP address of the mail is converted to IP4R format and the receive-MTA 300 queries the approved sender whitelist DNS server 1000. If the source IP address is valid, the whitelist DNS server is queried using the dynamically enhanced bounce address.

The result of the whitelist query may used to determine the validity of the usage of the dynamically enhanced bounce address in the mail. Namely, the query determines whether the dynamically enhanced bounce address is forged, no longer certified, otherwise invalid, or in some way improper, for the mail to which it is attached. Alternatively, the two query steps may be combined by querying the whitelist DNS 1000 with the dynamically enhanced bounce address and receiving a list of source IP addresses that are properly associated with the dynamically enhanced bounce address. Then, the source IP address of the message is compared with this list to determine its validity. The query may, for example, return an ‘A’ record including a coded class and reputation score in the form of an IP address. The present invention also encompasses more detailed queries about the sender's reputation via for example a DNS ‘TXT’ record, HTTP, LDAP, or other protocol. To enhance performance, the receive-MTA 300 may advantageously pass the coded class and reputation score results to the MDA 400 and log these data.

FIG. 6B shows exemplary steps of a method 311 for using a DKIM, a similar public/private key system, or other authentication method for Internet domain names to validate message senders and message campaigns. Steps 312, 314, 316 and 326 are the same as the identically-numbered steps of method 310. At step 323, the message content is read. At step 325, the message header and structure are parsed to extract a DKIM Signer, Selector and Signature, or other signature used in an authentication scheme. At step 327, the signer's DNS server, such as a certified or trusted server, is queried to retrieve the public key for the signature. Optionally, class and reputation for the campaign may also be obtained. At step 329, the message signature is verified using the public key. At step 331, the message content can be accepted or rejected, and the sender's policy may be applied to dispose of the message in a predetermined fashion if the signature is missing or invalid. The remaining steps of method 311 may proceed in the same way as previously described for method 310. Further details regarding receive-side MTA actions are provided below, with reference again the FIGS. 6A and 6B.

At the receiver side MTA (receive-MTA 300), the TCP connection from the send-MTA 200 is accepted 312. This starts-up an SMTP (for example, ‘EHLO’, etc.) dialog 314 with the send-MTA 200. The receive-MTA 300 receives and validates the bounce address, which it may reject 316. In one embodiment, the receive-MTA 300 identifies that the Bounce address is a dynamically enhanced bounce address. If the bounce address is not in the correct format, the validation process is exited 320. In an alternative implementation, the receive-MTA examines the message for an identifying message element, such as for example a public or private DKIM key.

In one embodiment, the IP address is converted to IP4R format and used to query an approved sender whitelist DNS server (list of authorized senders) 1000. As an example, a returned ‘A’ record determines whether that source IP address is authorized to send mail. (forged or no longer certified?). If not, the validation process is exited 322. In one embodiment, the receive-MTA 300 queries the approved sender whitelist DNS server 1000 with the dynamically enhanced bounce address or some other identifying element of the received message such as a DKIM key. The returned ‘A’ record indicates whether the sending customer is authorized to send this class of mail. In an alternative embodiment, the query of the dynamically enhanced bounce address or other identifying message element could return a list of source IP addresses and/or sender domain names associated with it, and then check whether the message source IP and/or domain name is one of these. The ‘A’ record may in one embodiment be a DNS record that has an internet address in it with a coded class and reputation score in the form of an IP address: i.e. “120.0.class.reputation 324.”

The receive-MTA 300 then receives and validates the message recipient(s) (may reject) 326, accepts/receives or rejects the message content 330, and performs routing by examining recipient address(es) and making routing decision(s) 332. This may include passing validation information to the delivery agent (MDA 400) 334. For performance optimization, the receive-MTA 300 may pass coded class and reputation score results to the MDA 400 for use in processing and disposition of mail. Finally, the receive-MTA 300 logs communication information 336.

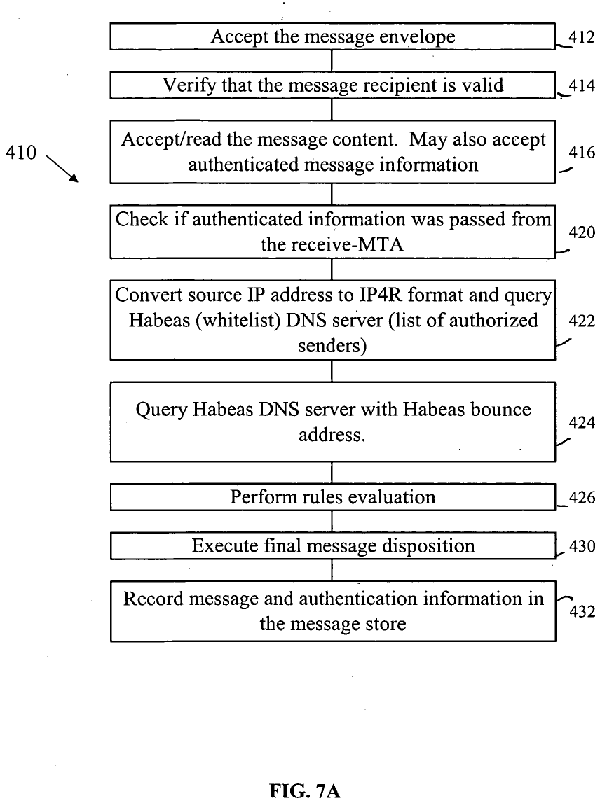

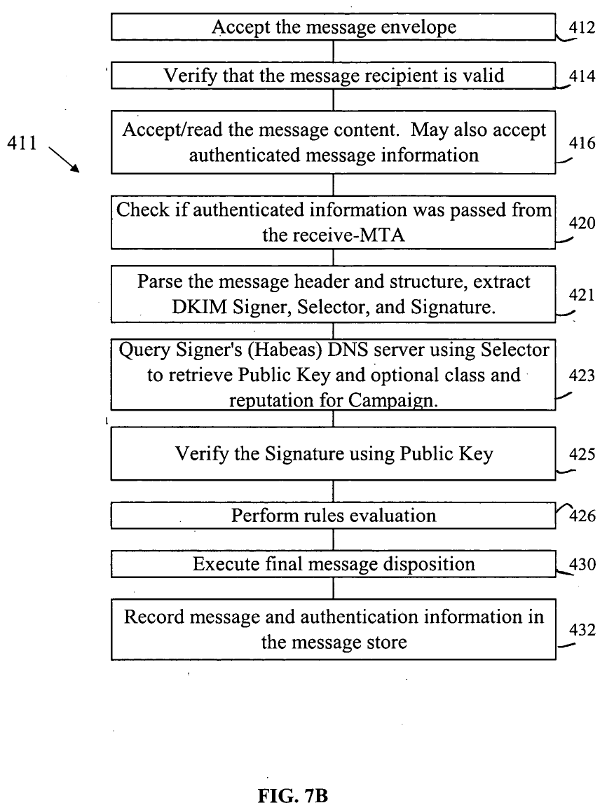

Exemplary steps of a method 410 performed at the MDA 400 are illustrated in FIG. 7A. First, the envelope is accepted at step 412. At step 414, the MDA 400 verifies that the recipient is valid by comparing the recipient address with local resources (to determine whether the recipient address is present). At step 416, the MDA 400 accepts and reads the content, including the message headers and body.

According to one embodiment of the present invention, when the content is accepted, the MDA may check whether authenticated information was passed from the receive-MTA, as indicated at step 420. This authenticated information may advantageously include class, reputation, campaign ID, and other authentication parameters. The message authentication information may advantageously be applied in rule evaluations to more accurately separate unsolicited from solicited e-mail messages.

If the receive-MTA did not perform the steps of contacting the approved sender whitelist DNS server 1000 to verify the dynamically enhanced bounce address and the source IP address, the MDA may perform these steps. Specifically, the source IP address of the mail is converted to IP4R format and the receive-MTA 300 queries the approved sender whitelist DNS server 1000, as indicated at step 422. If the source IP address is valid, the approved sender whitelist DNS server is queried using the dynamically enhanced bounce address, as indicated at step 424. The result of this query is used to determine the validity of the usage of the dynamically enhanced bounce address in the mail. Namely, the query determines whether the dynamically enhanced bounce address is forged, no longer certified, otherwise invalid, or in some way improper, for the mail to which it is attached. Alternatively, the two query steps may be combined by querying the approved sender whitelist DNS 1000 with the dynamically enhanced bounce address and receiving a list of source IP addresses that are properly associated with the dynamically enhanced bounce address. Then, the source IP address of the message is compared with this list to determine its validity.

The MDA may then apply a rules engine as indicated at step 426. Intervening steps 420, 422 and 424 are optional and are described below. Step 426 may comprise running one or more evaluation processes, such as for example a spam or virus filter; a prioritization, sorting, or workflow; or other applications. Next, the final message disposition is executed as indicated at step 430. This may include one or more of putting the message into a folder, delivering the message to another device (such as for example a pager, cell phone, personal data assistant, or other short messaging system device), forwarding the message to another user, auto-replying to the message (i.e. out of office message), or discarding or bouncing the message.

At step 432, the message storage system 500 provides permanent storage of the user's messages using a specified database or file system. User messages in the mail storage system may be stored with authenticated message parameters for use by the database file system and applications.

FIG. 7B shows exemplary steps of a method 411 using DKIM or a comparable public/private key system to validate source and campaign identifiers by an MDA. Steps of method 411 may be the same as identically-numbered steps of method 410 described above. At step 421, the message header and structure are parsed by the MDA to extract a DKIM Signer, Selector and Signature, or other authenticator used in a domain name authentication scheme. At step 423, the signer's DNS server, such as a certified or trusted server, is queried to retrieve the public key for the signature. Optionally, class and reputation for the campaign may also be obtained. At step 425, the message signature is verified using the public key. The remaining steps of method 411 may proceed in the same way as previously described for method 410.

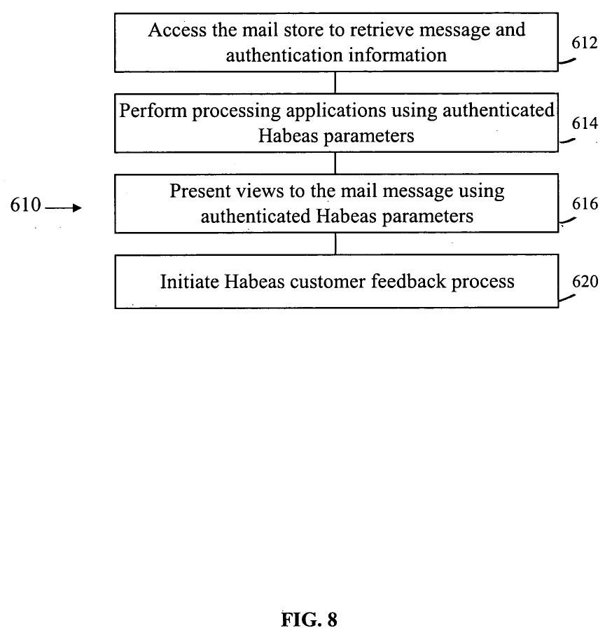

Exemplary steps of a method 610 performed at the receive-MUA 600 are illustrated in FIG. 8. The receive-MUA 600 gains access to the mail store 500 and reviews, reads, and/or manages the message, as indicated at step 612. This may include one or more actions such as retrieving, deleting, refoldering, copying, etc. At step 614, the receive-MUA acts as the user interface through processing steps such as spam or virus filtering, sorting, foldering and the like are performed, either manually by the customer or automatically. At step 616, the MUA also presents views to the mail received by the customer, including sorting, color coding, icon or tags, or the like, such that the views may be enhanced using dynamic reputation, class, or content data as described below. Optionally, this process may be enhanced using the message authentication data received from the send-MTA as well. The receive-MUA may optionally initiate a consumer feedback process at step 620. This may occur by the user clicking on a feedback URL in the message or alternatively through one or more automated processes. Additionally, the receive-MUA may make some or all of the approved sender whitelist DNS or dynamically enhanced bounce address data available for the consumer. For example, one or more columns may be provided in the mail view that permit the consumer to sort for messages based on class, reputation, content, etc.

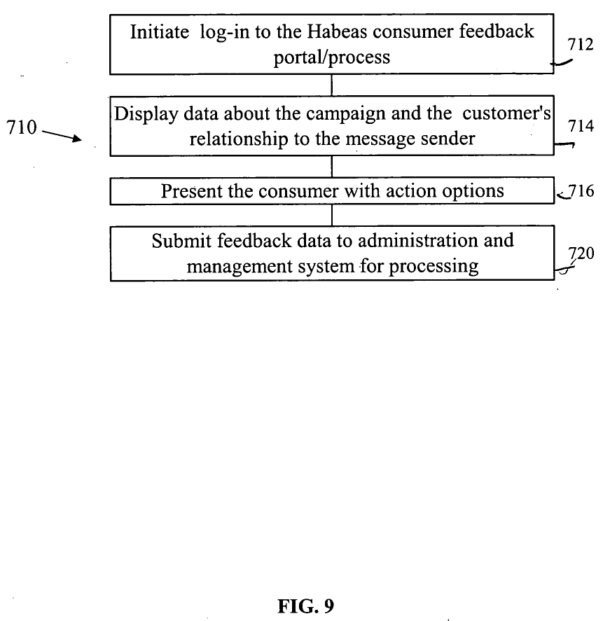

The feedback system 700 and the administration and management system are illustrated in FIG. 2. Referring to FIG. 9, exemplary steps of a feedback method 710 are shown for use with system 700. System 700 further includes a consumer portal (not shown).

The method is initiated at step 712 when a consumer performs a feedback providing action, such as for example clicking a URL with embedded information. This embedded URL comprises information about one or more of the message content, the mail campaign, the class of mail, the sender, the reputation, or the like. Upon initiation, the consumer portal provides a feedback display, advantageously in the form of a web form that is viewable by the consumer, as indicated at step 714. This display includes one or more of the campaign ID and description, the class of mail, the sender or campaign reputation, a description of the list the consumer's e-mail address is on, and how the consumer was placed on the list. The display present the consumer with one or more action options at step 716. These options may include, for example, requesting to opt-out of future messages in the campaign or from the sender, reporting the message as spam, or providing feedback to the sender about the content or desirability of the message. At step 720, feedback data collected from the recipient is submitted to an administration and management system for processing and use in classifying mail campaigns or sender reputations.

Feedback data aggregation and analytics may be executed according to one embodiment through a rating system that allows for ranking and reporting 800. in this example, feedback from the feedback system 700 is received 812. Data sources from the feedback system 700 to the administration system 800 include consumers (mail recipients). The feedback may include reporting of the mail as spam, and possibly a indicator of the quality of the mail. Additional consumer inputs may include answers to survey questions or thresholding, including for example one or more of frequency, content relevancy, subjective value of the offer, or a rating along a scale of acceptable to offensive. The consumer may also request to opt out of future campaigns by including a recipient e-mail address in the feedback. Optionally this system may add privacy, security, or list management processes.

Feedback may also be received from the send-MTA 200, the receive-MTA (300), and other intermediate MTAs. This feedback may include one or more of bounce statistics, including addresses to remove from the list, and other connection problems (for authenticated mail and/or data). Optionally a report that flags connection problems for ISPs may be provided. Additionally, other MTA log data may be reported.

Additional possible sources of feedback include seed mail boxes for mail delivery data associated with ISPs or mailing lists; tools such as search, research programs, and blacklist IP addresses; and direct certification and audit processes that support ongoing audit processes using policies, thresholds, and alerts.

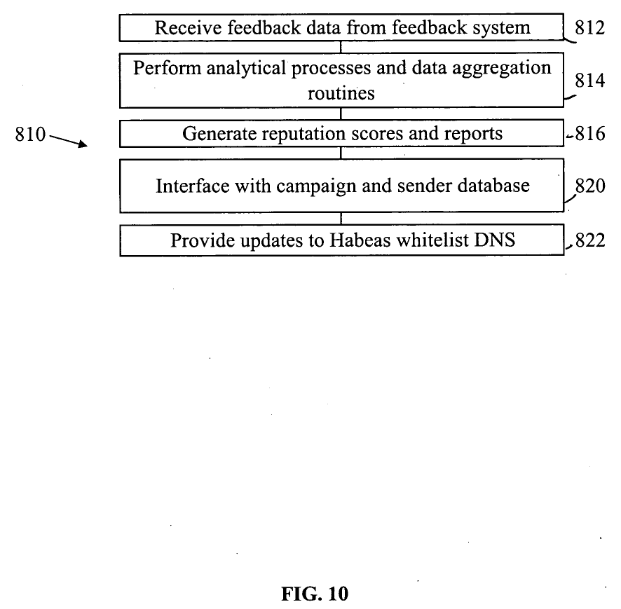

In a further embodiment, an administration and management system 800 and method are provided. An exemplary method 810, illustrated in FIG. 10, provides a rating system that allows for ranking and scoring of mail sent by a sender. At step 812, the system receives data from consumers, mail transfer agents (both sending and receiving), one or more seed mail boxes for testing the delivery and tracking systems, from additional sources such as search and research programs and IP address blacklists, and from ongoing direct certification and audit procedures. At step 814, the system then performs on or more analytical procedures on the data. These procedures may include audit compliance and threshold analyses, algorithms and heuristics for reputation scoring and auditing of sender IP addresses and mail campaigns and classes, and the like. Some representative but non-limiting examples of these processes include revoking certification, list management actions (add me, delete me), and modifying reputation scores in response to feedback. Reputation scores and reports based on processed data may be provided at step 816. In one embodiment of the present invention, volume data for messages received by an MTA are relayed to a private authentication server. The private authentication server may aggregate the volume data to generate statistics regarding the number, class, type, etc. of messages sent by a given sender. Such data may also be reported.

At step 820, reported data may be provided to campaign and sender databases maintained by the electronic mail system. Selected information may be maintained in the database for use in evaluating sender or campaign classification. To the extent that feedback data triggers a change in reputation or campaign classifications, appropriate updates may be provided to the system domain name server whitelist, as indicated at step 822. The data may also be used to generate alerts which trigger actions by senders or authenticating authorities.

Further details regarding certain aspects of the invention are provided in the section below.

Domain Keys Identified Mail (DKIM)

DKIM denotes a standardized public/private key system for authentication of a mail source. It makes use of the properties of a domain to provide more specific information than is available from a bare source IP address. Public domain name servers (DNS) map domains to a given IP address or set of addresses. The DKIM makes use of the DNS to obtain a public key from which the message signature can be authenticated. DKIM thereby avoids the need to attach information to the mail to uniquely identify it. DKIM is merely exemplary of a domain name authentication method that may be used with the invention, and the invention is not limited thereby.

When making use of DKIM methods, the domain call may be used to replace some aspects of a look-up to a warrant mark engine or database. It may still be desirable to retain certain aspects of a warrant engine, such as a seal and feedback function. Although not compatible with dynamically enhanced bounce addresses, DKIM obviates the need for them. DKIM provides that a public key retained at the DNS is paired with private key kept by the sender. A digital signature is created using the private key as a hash comprised of selected parts of the content plus the private key. The receiver queries the DNS to obtain the public key registered for the sender, which key can be used to decrypt the signature. If the message is not authentic, the signature will not be decrypted by the public key and can be identified as inauthentic.

A message can be signed an indefinite number of times, enabling operation of a trusted proxy for resigning and modification of source addresses. The message header indicates whether a message is signed. Multiple signatures, e.g., myfamily.com, myfamily.habeas.com, are permitted.

Dynamic Source IP Address

One embodiment of the present invention provides a method and system for applying a set of business rules to set the source IP address of individual messages sent from an E-mail server. The purpose of this is to support DNS-based white listing of certain classes of E-mail. No existing E-mail server supports the idea of shifting the source IP address based on business rules.

Most high-end SMTP Servers today do support virtual hosting, in which a single Server instance responds to a set of IP addresses and sends from a set of IP addresses, mimicking the behavior of multiple server host systems on a single host system. One existing mail transfer agent (MTA), “Port25 PowerMTA,” is known to have the ability to route messages from one virtual host to another, which has the external effect of shifting the source IP address. This mechanism is very indirect, however, and is clearly outside the design parameters of the MTA, requiring a vendor created custom configuration.

In another embodiment of the present invention, a method and system for accomplishing dynamic source IP addresses for outbound message are provided. The asynchronous proxy server (ASPS), described below, allows a sender-side MTA (send-MTA) to maintain a connection with a receiver-side MTA (receive-MTA) while checking and, if necessary, modifying the source IP address according to one or more business rules based on the content or class of the message, the reputation of the sender, and the like.

Asynchronous SMTP Proxy Server

In an embodiment of the invention, an asynchronous SMTP proxy server (ASPS) is provided for processing of outbound mail. This proxy server may be provided in various forms and configurations, an exemplary one of which—the ASPS—is described in more detail below.

The Asynchronous SMTP Proxy (ASPS) should comprise a light, fast, memory-based proxy server for SMTP. It provides the core functionality of the Habeas Warrant Mark Engine™. Its unique feature is the ability to defer the remote MTA connection and adjust the connection parameters based on SMTP elements received from the client MTA; in particular, the source IP address can be set based on the originator address, so as to support DNS-based white-listing filters.

A technology is provided that replaces traditional “white lists” for spam blocking. The key element of this is the Habeas Reputation Server™, a database that ranks E-mail senders and their campaigns based on recipient feedback and anti-spamming laws and standards.

Messages are identified by a reputation designator (for example the Habeas Warrant Mark™) that is inserted in the header of each outbound bulk E-mail message. This is a digital signature that uniquely identifies the originator of the message. The reputation designator also includes some information about the message, including a campaign identifier, the reputation score at the time the message was sent, how the recipient subscribed to the list, and an expiration date. A reputation seal (for example, the Habeas Seal™) may also be added to each outgoing E-mail. The reputation seal contains active hyperlinks or other comparable means for activating a software routine or accessing data over a network that the consumer may click to rate the E-mail, unsubscribe from the message, report the message as spam, or perform other tasks.

To support traditional ISP “white lists” filters, each message is also identified by selecting an appropriate source IP address when the message is submitted into the public network. This either requires support from the submitting List Server or MTA (perhaps via a plug-in), or the introduction of a filter that can alter the source IP address based on the originator of the message.

Some mail senders may not be in a position to modify their List Server or MTA to support reputation-based IP address selection. To support these customers, a Warrant Mark Engine may be provided. The Warrant Mark Engine may be an Internet Appliance Server that is inserted inline between the outgoing MTA and the public Internet. The Warrant Mark Engine will accept E-mail messages, insert a designator mark and seal (for example the Habeas Warrant Mark and Seal), and connect to the remote MTA using a source IP address that is based on the originator's E-mail address.

The ASPS software component will implement the core SMTP relay feature of the Warrant Mark Engine. Accordingly, this component should accomplish the following: sit between the outgoing MTA and public Internet, transparently route all non-SMTP traffic, and intercept outbound SMTP traffic. Additionally, it may accept outbound SMTP connections from the customer MTA, “spoof” the behavior of the remote MTA and capture the destination IP address; inspect the bounce address (also known as the envelope originator or the SMTP MAIL FROM) to determine whether the message is bulk or regular mail, and for bulk mail, identify the campaign ID; query a Reputation Server to obtain the parameters of the bulk mail campaign; add some type of sender identifier message element to the headers and/or bodies of the message(s); connect to the remote MTA at the IP address specified by the client (sender) MTA, with a source IP address determined by the campaign ID; and deliver the modified message to remote MTA. This may be the receive-MTA as discussed above.

By way of background, SMTP filtering, relaying, and proxy software has already been written for other applications, much of it freeware or open source. Existing software broadly falls into two categories, traditional Message Transfer Agents (MTAs) like Sendmail and qmail, and SMTP Proxy Servers like ssmtp and fluffy.

Traditional MTAs are generally not appropriate for ASPS functions for the following reasons, among others. An MTA is a store-and-forward device. It takes full responsibility for a message, then forwards it on to the next MTA. If a storage device or the server itself fails, all stored messages will be lost. Also, an MTA requires considerable management and configuration, even when it is used only for a trivial application. For example, it needs some level of routing rules, it must have access to the DNS to do hostname resolution and MX lookup, it must be able to canonicalize its own hostname (via the DNS or other means), and it requires management interfaces to help deal with down hosts, “stuck” messages, and storage exhaustion. Further, the performance of the WME needs to at least equal that of the customer's outbound MTA. If the WME is itself running an MTA, the WME hardware platform would have to be roughly equal in performance to the platform that is running the customer's outbound MTA. If the customer is using a highly optimized bulk-mail delivery system like Lyris List Manager, then the WME would need substantially faster hardware than the customer's MTA. These may be physically unobtainable.

Customers often have a large investment in their outbound MTA. High-end MTAs support complex delivery features, such as controls on the number of concurrent connections, timers to hold and reuse existing sessions, monitoring interfaces that show where traffic is backlogged, different routes to use at different times of day or when certain failures occur, and configurable rules for retrying failed connections. All of these features and more will be disabled when an extra MTA is introduced in the path; the WME would become the customer's outbound MTA.

The alternative is an SMTP proxy server. A proxy server maintains no persistent state and can be memory based, yielding performance much higher than an MTA on modest hardware. A proxy also requires very little configuration or management. However, the requirements stated above cannot be achieved with the currently available implementations. The available commercial-quality high-performance proxy servers, including, for example, those from Trend Microsystems and Postini, are inbound proxy servers. They lack the ability to connect to multiple remote systems based on the remote IP address provided by the customer MTA. The available inbound proxy servers, most of which are freeware or open source, are designed for personal use and of the quality of a student programming project. Most are implemented using slow interpretive languages, like perl and Visual Basic. All contain serious security, performance, and reliability problems. All of the available proxy servers support synchronous operation only. That is, they are designed only for a strict lock-step sequence of “client command, echo command to remote, remote response, echo response to client.” The asynchronous capability required by the invention exceeds the capacity of existing proxy server design assumptions and would require at minimum extensive rework to achieve. It is believed preferable to develop and code a suitable proxy server from an adequately robust set of design assumptions.

Components of an ASPS according to the invention may include: an SMTP Server implementation that will accept messages from sender MTAs, an SMTP Client that will send messages to remote MTAs, at the IP addresses specified by the sender MTA, and a memory-based scheduler that manages a message queue between server and client, notifying the client when sufficient information is available to proceed. Further features may include a Filter API that has access to all elements of the message (both envelope and headers), offers the ability to modify any elements of the message, and can signal when additional information is needed before proceeding with a client action. Although the SMTP Server, Client, and Scheduler will all be strictly memory-based, the Filter API may support the use of disk-based queues as well as memory streaming if necessary to support arbitrarily large messages. A logging module may also be provided for recording delivery events, communications status, and error events. A Monitoring module may report current Proxy status, to be used by availability/recovery tools. In addition, a Delivery Status,Notification (DSN) module may allow the Proxy to send E-mail notifications to the client (customer) MTA. This component is generally optional, though it may be necessary when the Proxy supports full extended DSNs. A configuration module may specify Proxy configuration parameters, such as for example the location of the Reputation Server.

This aspect of the present invention lends itself well to small incremental feature development. This is quite different from classical SMTP MTA projects, which tend to require large pieces to be developed all at once. The extended SMTP features may be negotiated separately between the send-MTA and apx and between apx and the remote (receive) MTA.

Senders using an ASPS may insert the proxy server as an appliance in their outbound E-mail path. Failure of apx could result in blockage of all the customers' outgoing E-mail, not just the bulk E-mail. As such, apx should be coded and tested to be highly reliable. It should also support availability features, like automatic recovery (restart) and the like.

In one embodiment, the proxy server uses, for example, the Habeas Mark and Seal Library (wml) to add the Habeas Warrant Mark and Habeas Seal to outgoing messages. The wml is a portable software object library that provides methods to add, modify, or verify a Habeas Warrant Mark or Habeas Seal in RFC 822 messages.

In one embodiment, and by way of example only, the deferred connection protocol flow-may be as indicated in Table I below:

TABLE I

| | | Remote (Receive) |
|---|---|---|
| Sender MTA | apx Proxy | MTA |
| TCP Connect | | |
| Src: 64.68.120.99 | □ | |
| Dst: 64.4.50.50 | | |
| | □ TCP Accept | |
| | □ Data: 220 apx.webex.com | |
| Data: EHLO webex.com | □ | |
| | □ Data: 250 apx.webex.com | |
| Data: MAIL FROM: | TCP Connect | |
| <campaign123@webex.com> | □ Src: 64.68.1.2 | □ |
| | Dst: 64.4.50.50 | |
| | | □ TCP Accept |
| | | □ Data: 220 hotmail.com |
| | Data: EHLO webex.com | □ |
| | | □ Data: 250 hotmail.com |
| | Data: MAIL FROM: | □ |
| | <campaign123@webex.com> | |
| | □ Data: 250 Sender OK | □ Data: 250 Sender OK |
| Data: RCPT TO: | □ Data: RCPT TO: | □ |
| <joe.cool@msn.com> | <joe.cool@msn.com> | |
| | □ Data: 250 Recipient OK | □ Data: 250 Recipient OK |
| Data: RCPT TO: | □ Data: RCPT TO: | □ |
| <clark.kent@msn.com> | <clark.kent@msn.com> | |
| | □ Data: 250 Recipient OK | □ Data: 250 Recipient OK |
| Data: DATA | □ Data: DATA | □ |
| | □ Data: 354 Ready | □ Data: 354 Ready |

Managing Extended SMTP Features

The deferred connection behavior of apx means that the extended SMTP (EHLO) parameters may be negotiated separately between the between the send-MTA and apx, nd between apx and the remote (receive) MTA. This is a major difference from conventional synchronous proxy servers, and in this respect apx is more “MTA-like” than “proxy-like.” The send-MTA will see the set of extended features offered by apx, and apx should advantageously be prepared to perform protocol conversions in real-time for those features that it supports but the remote (receive) MTA does not.

The following extended SMTP features would advantageously be supported by apx:

ENHANCEDSTATUSCODES (RFC 2034): Ignoring this extension could result in the proxy failing to notify the send-MTA of the presence of the enhanced status codes, possibly causing faulty generation of delivery status reports. The easiest way to support this feature is for apx to offer ENHANCEDSTATUSCODES. If the remote (receive) MTA does not support this extension, apx could modify all responses from the remote (receive) MTA to insert an enhanced status code. This could be done using a static mapping of old-style RFC821 status codes to enhanced codes.

The following extended SMTP features are not mandatory, although they are relatively easy to implement and failure to support them could degrade the performance or functionality of the send-MTA:

PIPELINING (RFC 2920): Ignoring this extension should cause no loss of functionality, but it could affect performance when PIPELINING is supported by both the send- and remote (receive) MTAs. Supporting PIPELINING in the server is trivial; supporting it in a client is more difficult, which is why very few send-MTAs support it.

The following extended SMTP features could affect the performance or functionality of the send-MTA, but may be difficult to support in an asynchronous proxy server:

8BITMIME (RFC 1652): Ignoring this extension could cause the send-MTA to encode all 8-bit body parts to quoted-printable or base64, decreasing both MTA performance and network performance. To support this, apx could offer 8BITMIME, and then be prepared to encode body parts itself should the remote (receive) MTA not support 8BITMIME.

Having thus described a preferred embodiment of method and system for electronic mail, it should be apparent to those skilled in the art that certain-advantages of the within system have been achieved. It should also be appreciated that various modifications, adaptations, and alternative embodiments thereof may be made within the scope and spirit of the present invention. For example, a system implement using the Internet has been illustrated, but it should be apparent that the inventive concepts described above would be equally applicable to other computer networks. The invention is defined by the following claims.

What is claimed is:

1. A method for enhanced processing of electronic mail, comprising the steps of:
classifying an outbound electronic mail message; and
making an assertion about the outbound electronic mail message based on the classification.

2. The method of claim 1, further comprising querying a server to obtain a sending parameter corresponding to an item selected from the group consisting of (a) the assertion and (b) content of the electronic mail message.

3. The method of claim 1, further comprising modifying the message to include a modified message element indicative of the assertion.

4. The method of claim 3, further comprising including the modified message element in a message header.

5. The method of claim 1, further comprising generating a sending parameter corresponding to an item selected from the group consisting of (a) the assertion and (b) content of the electronic mail message.

6. The method of claim 1, wherein the classifying step is performed using a sender-side agent selected from the group consisting of (a) a mail user agent and (b) a mail transfer agent.

7. The method of claim 1, wherein the classification step further comprises evaluating at least one element of the outbound electronic mail message using a set of business rules.

8. The method of claim 7, wherein the evaluating step further comprises evaluating at least one element of the outbound electronic mail message comprising a an element selected from at least one of a (a) a sender IP address, (b) a reputation designator, (c) a reputation certification, and (d) a dynamically enhanced bounce address.

9. The method of claim 7, wherein the evaluating step further comprises evaluating at least one element of the outbound electronic mail message comprising a sender IP address, further comprising verifying the sender IP address.

10. The method of claim 9, wherein the verifying step further comprises verifying the sender IP address by querying a directory service to which the sender IP address belongs.

11. The method of claim 7, wherein the evaluating step further comprises evaluating at least one element of the outbound electronic mail message comprising an encrypted signature associated with a cryptographic key.

12. The method of claim 11, further comprising verifying the signature by directly querying a directory service to determine whether the cryptographic key is authorized.

13. The method of claim 12, wherein the querying step comprises querying the directory service selected from the group consisting of (a) a domain name server, (b) a who is server, (c) a CCITT X.500 directory service, and (d) a public directory service using a Lightweight Directory Access Protocol.

14. The method of claim 12, further comprising extracting a campaign ID from a message element, wherein the encrypted signature comprises the campaign ID, and using the campaign ID as a selector to query the directory service.

15. The method of claim 1, wherein the classification step further comprises evaluating at least one element of the outbound electronic mail message using feedback information collected from individual recipients of other electronic messages of the same class.

16. The method of claim 1, wherein the classifying step is performed using a an asynchronous proxy server system configured to accept an outbound electronic message from a sender-side mail transfer agent and send the outbound electronic message to a receiver-side mail transfer agent.

17. An asynchronous proxy server system for handling electronic mail, comprising:
an asynchronous SMTP server configured to accept an outbound electronic message from a sender-side mail transfer agent and send the outbound electronic message to a receiver-side mail transfer agent; and
an SMTP client operatively associated with the SMTP server, the SMTP client configured to connect asynchronously between the sender-side mail transfer agent and the receiver-side mail transfer agent to assign a designated sender address to the outbound electronic message.

18. The asynchronous proxy server system of claim 17, wherein the SMTP client is configured to maintain a connection to the sender-side mail transfer agent and to establish a dynamic, separate connection to the receiver-side mail transfer agent.

19. The asynchronous proxy server system of claim 17, further comprising a memory-based scheduler operatively associated with the SMTP client and configured to notify the SMTP client when sufficient information is available to proceed with sending the outbound electronic message to the receiver-side mail transfer agent.

20. The asynchronous proxy server system of claim 17, wherein the SMTP client is further configured to select the designated sender address using a reputation designator associated with the outbound electronic message.

21. The asynchronous proxy server system of claim 17, wherein the SMTP client is further configured to add a reputation seal to the outbound electronic mail message.

22. The asynchronous proxy server system of claim 17, wherein the SMTP client is further configured to deliver the outbound electronic mail message having the designated sender address to the receiver-side mail transfer agent.

23. The asynchronous proxy server system of claim 17, further comprising a filter API configured to support disk-based message queuing operatively associated with the SMTP client.

24. The asynchronous proxy server system of claim 17, further comprising a logging module operatively associated with the SMTP client, the logging module configured to record at least one of delivery events, communication status, and error events.

25. The asynchronous proxy server system of claim 17, further comprising a monitoring module operatively associated with the SMTP client, the monitoring module configured for reporting current status of the proxy server system.

26. The asynchronous proxy server system of claim 17, further comprising a delivery status notification module operatively associated with the SMTP client, the delivery status notification module configured to provide electronic notifications of delivery status to a customer-side mail transfer agent.

27. A method for managing a connection between a local mail transfer agent and a remote mail transfer agent for electronic mail messages, comprising the step of:
establishing a connection between a local mail transfer agent and a remote mail transfer agent for electronic mail messages;
evaluating an outbound electronic mail message; and
comparing a message element of the outbound electronic mail message with an expected data structure.

28. The method of claim 27, further comprising maintaining the connection while the performing the comparing step.

29. The method of claim 27, further comprising amending the message element if the message element differs from the expected data structure.

30. The method of claim 27, wherein the comparing step further comprises comparing the message element comprising a sender IP address.
